(19) United States
(12) Patent Application Publication
(10) Pub. No.: US 2003/0118947 A1
(43) Pub. Date: Jun. 26, 2003

(54) System and method for selective deposition of precursor material

(75) Inventor: Robert W. Grant, Hershey, PA (US)

Correspondence Address: PATTON BOGGS, PO BOX 270930, LOUISVILLE, CO, 80027, US

(73) Assignee: Primaxx, Inc., Allentown, PA (US)

(21) Appl. No.: 10/310,473

(22) Filed: Dec. 4, 2002

Related U.S. Application Data
(60) Provisional application No. 60/337,638, filed on Dec. 4, 2001.

(51) Int. Cl. G03C 5/00

(52) U.S. Cl. 430/311; 430/322

(57) ABSTRACT

A method for selective deposition of integrated circuit thin film, the method comprising: providing a substrate having a surface in a deposition chamber; depositing a photosensitive film on the substrate surface; selectively exposing a portion of the film to UVL (ultraviolet light), thereby creating an exposed film portion and an unexposed film portion; providing, in the deposition chamber, a mist of liquid precursor particles having a first polarity; and utilizing the first polarity to migrate the mist particles to one of either the exposed film portion or the unexposed film portion.

### RELATED APPLICATIONS

The instant application claims the benefit of Provisional U.S. patent application Serial No. 60/337,638 entitled “METHOD AND APPARATUS FOR DEPOSITING PRECURSOR MATERIAL ON CIRCUIT ELEMENTS WITHOUT DEPOSITING ON UNWANTED AREAS” filed Dec. 4, 2001, the disclosure of which application is hereby incorporated by reference.

### BACKGROUND OF THE INVENTION

1. Field of the Invention

The invention relates to methods of fabricating integrated circuits, and more particularly to a method of improving the formation of a thin film of solid material during the fabrication of integrated circuits by deposition of precursor material on selected portions of a substrate surface.

2. Statement of the Problem

The manufacture of integrated circuits entails a series of steps in which layers of materials are sequentially deposited, patterned, and developed to form the various components of the circuit. One of the problems associated with integrated circuit manufacture is that thin film layers, once deposited, must usually be patterned and etched using complex, multi-step processes. The patterning and etching processes are time-consuming and expensive; furthermore, the etching mechanisms to remove certain layers often cannot be exactly controlled, resulting in damage to the integrated circuit and in decreased manufacturing yields. The above-listed problems are accentuated where it is desired to conduct selective removal, through etching, of heavy molecules such as multi-metal oxides, such as indium tin oxide (ITO), strontium bismuth titanate (SBT), and barium strontium titanate (BST). These compounds are difficult to remove with reactive ion etching (RIE) and with other methods.

A selective deposition method is disclosed in U.S. Pat. No. 6,448,190 issued Sep. 10, 2002 to Hayashi et al., which is incorporated by reference. The disclosed selective deposition method relies upon a disparity in physical properties of two substrate surfaces to deposit precursor material on one of the surfaces but not on the other surface. However, this approach requires either that different materials be used for different portions of the substrate and/or that different portions of the substrate be processed differently prior to the selective deposition process.

An alternative approach to selective deposition is disclosed in Japanese Patent Application No. 05204567. In this case, a plasma Chemical Vapor Deposition (CVD) process is employed to deposit precursor material on protruding portions of a substrate. Another approach involving CVD plasma is disclosed in Japanese Patent Application No. 02143701. However, a limitation of these disclosed methods is that CVD plasma is not suitable for stoichiometric deposition of heavy molecules such as multi-metal oxides.

Accordingly, there is a need in the art for a system and method for selective deposition suitable for deposition of heavy molecules, including multi-metal oxides, on a substantially uniform substrate.

### SOLUTION

The present invention advances the art and helps to overcome the aforementioned problems by providing a system and method for providing selective deposition of misted precursor material onto a charge-patterned substrate surface. The inventive system and method is preferably used in conjunction with Liquid Source Misted Chemical Deposition (LSMCD) and is preferably able to selectively deposit various materials including heavy molecules such as multi-metal oxides like ITO, SBT, and BST.

In a preferred embodiment, a substrate is coated with a patterning film, which is preferably organic and preferably photosensitive. Generally, the surface of the patterning film initially has a slight positive charge due to the presence of hydrogen-terminated molecules. UVL (ultraviolet light) exposure of this film generally dislodges the hydrogen-terminated molecules at the film surface, thereby rendering the surface charge less positive. After UVL exposure, an exposed region may be electrically neutral or electrically negative but in either case will be less electrically positive than the unexposed regions. Accordingly UVL exposure of a film through a mask preferably makes exposed film regions electrically neutral or negative and preferably leaves unexposed film regions in their original positively charged state.

After the film is exposed, precursor mist particles, which preferably receive a charge in an LSMCD deposition chamber, are directed toward the selectively charged substrate surface. In the preferred embodiment, a negatively charged charging plate tends to encourage migration of positively charged precursor mist droplets toward the substrate and to inhibit a similar migration for negatively charged droplets. The positively charged mist droplets are preferably directed toward the UVL exposed regions and away from the unexposed regions on the film above the substrate. Thus, in this embodiment, the UVL exposed regions are hydrophilic, and the unexposed regions are hydrophobic. However, the correlation between negative surface charge and either hydrophilia or hydrophobia could be reversed with different charging conditions of the field screen and substrate charging plate.

In this embodiment, precursor material preferably accumulates on the hydrophilic portions and not on other portions of the substrate surface. Thereafter, residual patterning film is burned off in a furnace anneal and/or dissolved away in subsequent substrate processing. Accordingly, the disclosed method preferably enables selective deposition of misted precursor material on a substrate according to a mask pattern.

The above and other advantages of the present invention may be better understood from a reading of the following description of the preferred exemplary embodiments of the invention taken in conjunction with drawings in which:

### BRIEF DESCRIPTION OF THE DRAWINGS

FIG. 1 is a side diagrammatic view of an LSMCD system according to a preferred embodiment of the present invention;

FIG. 2 is a side diagrammatic view of an LSMCD system according to an alternative embodiment of the present invention;

FIG. 3 is a side diagrammatic view of a selective deposition of precursor mist droplets employing the LSMCD system of FIG. 1; and

FIG. 4 is a side diagrammatic view of apparatus for exposing a film on a substrate with ultraviolet light.

### DETAILED DESCRIPTION OF THE PREFERRED EMBODIMENT

This disclosure describes a system and method for depositing precursor material on selected circuit or other elements of a substrate while avoiding deposition in unselected areas. U.S. Pat. No. 6,116,184 issued Sep. 12, 2000 to Solayappan et al., the disclosure of which is incorporated by reference as though fully disclosed herein, describes a method and apparatus in which a precursor is deposited using LSMCD (Liquid Source Misted Chemical Deposition) on integrated circuit elements. The precursor is then treated to form a solid thin film on the substrate.

The term “mist” as used herein is defined as fine droplets or particles of a liquid and/or solid carried by a gas. The term “mist” includes an aerosol, which is generally defined as a colloidal suspension of solid or liquid particles in a gas. The term “mist” also includes a fog, as well as other nebulized suspensions of the precursor solution in a gas. Since the above term and other terms that apply to suspensions in a gas have arisen from popular usage, the definitions are not precise, overlap, and may be used differently by different authors. In general, the term “aerosol” is intended to include allthe suspensions included in the text “Aerosol Science and Technology” by Parker C. Reist, McGraw-Hill, Inc., New York, 1983, which is incorporated by reference. The term “mist” as used herein is intended to be broader than the term “aerosol”, and includes suspensions that may not be included under the terms “aerosol” or “fog”. The term “mist” is to be distinguished from a gasified liquid, that is, a gas. The mists of this invention are created from a liquid precursor, and the resulting precursor mist droplets have an average diameter of less than one micron and preferably in the range of 0.2 microns-0.5 microns. The terms “atomize” and “nebulize” are used interchangeably herein in their usual sense when applied to a liquid, which is to create a spray or mist, that is, to create a suspension of liquid droplets in a gas.

The term “thin film” is used herein as it is used in the integrated circuit art. Thin film means a film of less than one micron in thickness. The thin films disclosed herein are generally less than 0.5 microns in thickness. Preferably, the films formed by the apparatus described herein are less than 300 nm thick, and most preferably are less than 200 nm thick. Films of from 20 nm to 100 nm are routinely made by the devices according to the invention. These thin films of the integrated circuit art should not be confused with so-called thin coatings or films in so-called “thin-film capacitors”. While the word “thin” is used in describing such coatings and films, these are “thin” only in respect to macroscopic materials and are generally tens and even hundreds of microns thick. The non-uniformities in such “thin” coatings are much larger than the entire thickness of a thin film as used herein; thus, the processes by which such coatings and films are made are considered by those skilled in the integrated circuit art to be incompatible with the integrated circuit art.

The U.S. Pat. No. 6,116,184 discloses a method in which an entire surface of a substrate is coated using an electrostatic field and charged precursor droplets of sub-micron size. While depositing precursor material on microelectronic circuits intended for use in the ferroelectric random access memory (FERAM) market, the inventor noticed that certain areas of the substrate were difficult to wet. Considerable effort was expended to overcome this limitation with various different substrate treatments. The inventor discovered that certain areas could be selectively coated by creating targeted areas on a substrate whose electrical charge could be modified, thereby providing either hydrophilic or hydrophobic regions. Although discovered while experimenting with processes for manufacturing integrated circuit memories, the described selective deposition process can find application in such fields as microelectronics, MEMS (Micro Electro Mechanical Systems), including MEMS-related automated test devices, optics, flat panel displays, and pharmaceuticals, including gel test dishes where enzymes can be beneficially selectively deposited, among others.

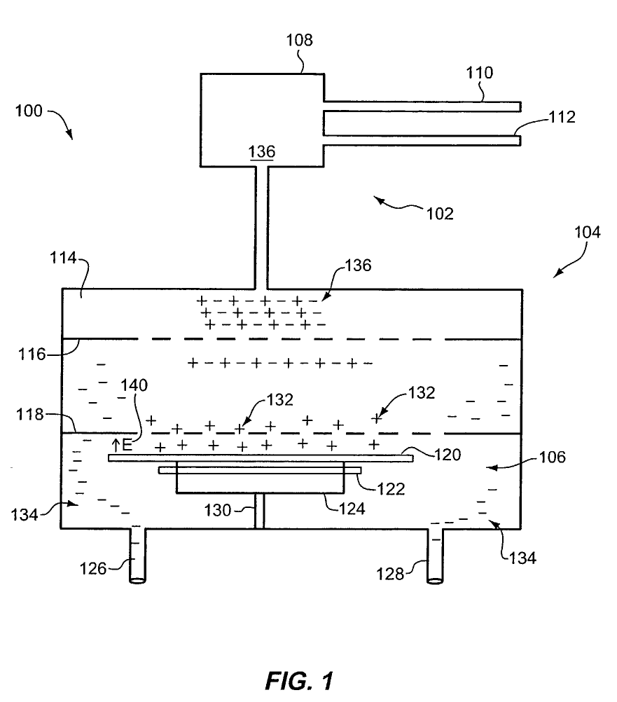

Because of the difficulty of removing certain complex metal oxides using standard photoresist patterning and etching processes, the inventor concluded that deposition of such metal oxides was a suitable candidate for selective deposition. Specifically, metal oxides were deposited on charge patterned areas including conductive lines or capacitor dielectrics. FIGS. 1-3 depict selective deposition employing LSMCD.

To ensure that the electrostatic forces prevail over gravitational forces, it is preferable to employ micron or sub-micron size mist droplets in connection with the present invention. An atomizer suitable for producing very small droplets is disclosed in co-pending, commonly assigned application docket number 13180.114, entitled “CHEMICAL VAPOR DEPOSITION VAPORIZER”, the disclosure of which application is hereby incorporated by reference. Generally, the gravitational force operating on droplets significantly larger than one micron in diameter precludes the use of such droplets in the selective deposition system disclosed herein.

FIG. 1 is a side diagrammatic view of an LSMCD system 100 according to a preferred embodiment of the present invention. In this embodiment, LSMCD system 100 preferably includes fluid supply system 102, deposition chamber 104, and substrate support assembly 106.

In this embodiment, fluid supply system 102 preferably includes aerosol generator 108, carrier gas conduit 110, and precursor conduit 112. Preferably, carrier gas conduit 110 and precursor supply 112 are coupled to aerosol generator 108. Aerosol generator 108 is preferably located above and is preferably coupled to deposition chamber 104. Preferably, aerosol generator 108 is configured to generate micron and sub-micron sized precursor droplets (or precursor particles).

In this embodiment, manifold 114 is located at the top of deposition chamber 104. Preferably, distributor plate 116 is located below manifold 104. A full description of the components described herein and of the LSMCD process may be found in U.S. Pat. No. 6,258,733 issued Jul. 10, 2001 to Solayappan et al., the disclosure of which patent is hereby incorporated by reference. Distributor plate 116 includes a series of closely spaced gaps which provide a dispersal of the carrier gas—precursor combination.

In this embodiment, field screen 118 is preferably located below distributor plate 116 and above substrate 120. An electric field is preferably formed between field screen 118 and substrate charging plate 122. In this embodiment, substrate support assembly preferably includes support link 130. Substrate holder 124 is preferably located above support link 130. Substrate holder 124 is preferably coupled to a high voltage power source (not shown). Substrate charging plate 122 is preferably located on substrate holder 124 and below substrate 120. Preferably, gas outlets (or exhaust ports) 126 and 128 are located at the bottom end of deposition chamber 104, on the left and right sides, respectively, to effect a uniform gas flow over substrate 120.

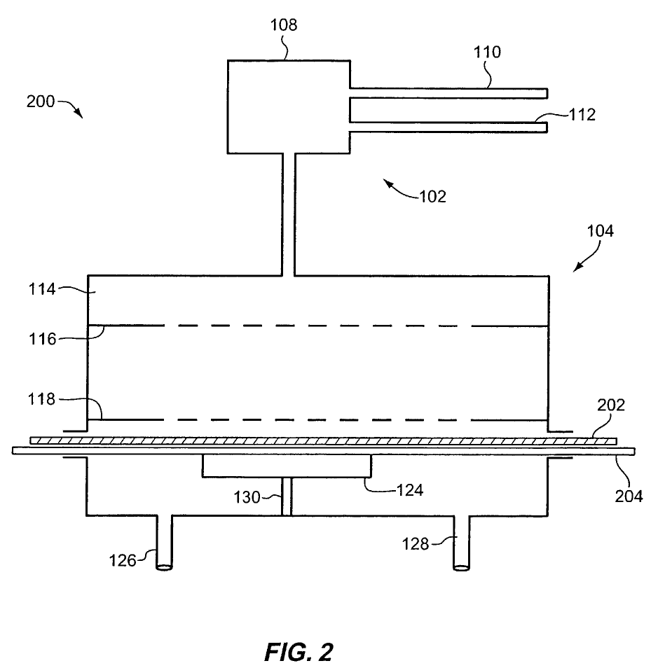

FIG. 2 is a side diagrammatic view of an LSMCD system 200 according to an alternative embodiment of the present invention. The embodiment of FIG. 2 differs from that of FIG. 1 in that substrate (or substrate ribbon) 202 is a continuously moving “ribbon” substrate instead of the single fixed substrate 120 of FIG. 1. An additional difference is that the substrate charging plate 204 of FIG. 2 is longer to accommodate a substantial length of substrate 202. Preferably, substrate 202 moves with respect to a fixed substrate charging plate 204 when such movement is desired. Otherwise, the structure of FIG. 2 is the same as that of FIG. 1, and the discussion of that structure will therefore not be repeated in this section. As alternatives to moving a substrate below stationary deposition equipment, movable deposition equipment could be moved over a stationary substrate, or a moving charged web could transport the substrate 202 or ribbon substrate. Since the flow of mist droplets 136, positively charged droplets 132, and negatively charged particles 134 are discussed below in connection with FIG. 1, depiction of these features is omitted in FIG. 2 for the sake of simplicity.

FIG. 4 is a side diagrammatic view of apparatus for exposing a film 406 on a substrate 120 with ultraviolet light 412. Attention is now directed to a system and method for producing a film 406 having negatively charged, or less positively charged, portions 408 and 410, which in the preferred embodiment are hydrophilic with respect to positively charged precursor mist droplets. In this embodiment, ultraviolet light source 404 directs ultraviolet light 412 through mask 402 to film 406 above substrate 120. Preferably, film 406 is sufficiently thin that, after ultraviolet light exposure, electrically neutral or electrically negative regions 408 and 410 are effectively “on” substrate 120.

The use of photosensitive films has also been practiced in systems and methods disclosed in issued U.S. Pat. Nos. 5,605,723 issued Feb. 25, 1997 to Ogi et al.; 5,630,872 issued May 20,1997 to Ogi et al.; 6,022,669 issued Feb. 8, 2000 to Uchida et al.; 5,792,592 issued Aug. 11, 1998 to Uchida et al.; and 5,849,465 issued Dec. 15, 1998 to Uchida et al., which patents are hereby incorporated by reference. Numerous organic photosensitive materials have been found useful in forming thin films. In these patents, material for forming a photoelectric film is incorporated as part of a precursor material and is deposited on a substrate by one of various known deposition methods. In contrast, in this disclosure, the photosensitive film is deposited first, exposed to radiation, and then the precursor material is deposited by a misted deposition process according to the invention.

In this embodiment, substrate 120 is preferably made of quartz, although other materials may be employed. Film 406 is preferably a photosensitive material and is preferably organic. However, other materials, the electrical surface charge of which may be modified through exposure to ultraviolet light, may be employed. Preferably, film 406 initially has positive surface charges 412 on upper surface 414. In this embodiment, the initially positive surface charges 412 arise from the prevalence of hydrogen terminations for molecules forming film 406.

Preferably, ultraviolet light source 404 directs ultraviolet light 412 toward mask 402. Preferably, mask 402 blocks transmission of ultraviolet light 412 in some regions and not in others, as is generally the case with optical masks. In this embodiment, those regions not exposed to ultraviolet light 412 preferably retain their initial positive surface charges 412. Preferably, in regions 408 and 410 of film 406, upper surface 414 is exposed to ultraviolet light 412, the positively charged hydrogen terminations are dislodged or oxidized, and a more negative surface charge results. The resulting “more negative” charge may be electrically neutral, that is, equal to the potential of the pertinent electrical ground. Alternatively, the “more negative” charge may be electrically negative. In either case, regions 408 and 410 are more electrically negative than regions 412. Accordingly, positively charged particles, such as positively charged precursor mist droplets 132, will tend to be driven away from regions 412 and toward regions 408 and 410. Thus, for the particular case (as with the preferred embodiment herein) where the pertinent liquid consists of positively charged particles, the negatively charged (or electrically neutral) regions 408 and 410 are hydrophilic. However, in an alternative embodiment, where liquid consisting of negatively charged particles is directed at surface 414, regions 408 and 410 would preferably be hydrophobic.

The selective deposition of precursor material according to the preferred embodiment is now described with respect to FIGS. 1, 3, and 4. Preferably, precursor liquid from precursor conduit 110 is misted 136 in aerosol generator 108 with the aid of carrier gas from carrier gas conduit 112. Consistent with the general properties of such misting operations, about one half each of mist droplets 136 are positively charged 132 and one half negatively charged 134. Preferably, a homogeneous mix of mist droplets 136 of different polarities exists within aerosol generator 108. In this embodiment, mist 136 is then directed toward manifold 114. Mist 136 then moves past distributor plate 116 and toward substrate 120. Preferably, distributor plate 116 operates much as showerhead dispensers, the function of which is known to those skilled in the art.

In this embodiment, field screen 116 and substrate charging plate 122 preferably cooperate to produce electric field 140. Electric field “E” 140 points upward, indicating a direction from positive to less positive electric charge. In the preferred embodiment, substrate charging plate 122 is negatively charged, and field screen 118 is preferably at electrical ground. Electric field 140 preferably imparts a force on mist droplets 136 equal to E•Q, or the product of electric field 140 strength and the charge “Q” of the droplets. Electric field 140 preferably encourages the migration of positively charged droplets 132 toward substrate 120 and preferably equally strongly inhibits the migration of negatively charged droplets 134 in that direction. The combination of the repulsion of negatively charged droplets from substrate 120 and the general downward flow of mist 136 preferably causes negatively charged droplets 134 to drift toward gas outlets 126 and 128. Accordingly, a preferably all-positive flow of droplets 132 proceeds past field screen 118 toward substrate 120. Electric field 140 effectively operates as the first of two factors controlling the flow of droplets near the surface of substrate 120 in LSMCD system 100. The second factor is the surface charge on substrate 120 surface 138 which is discussed next.

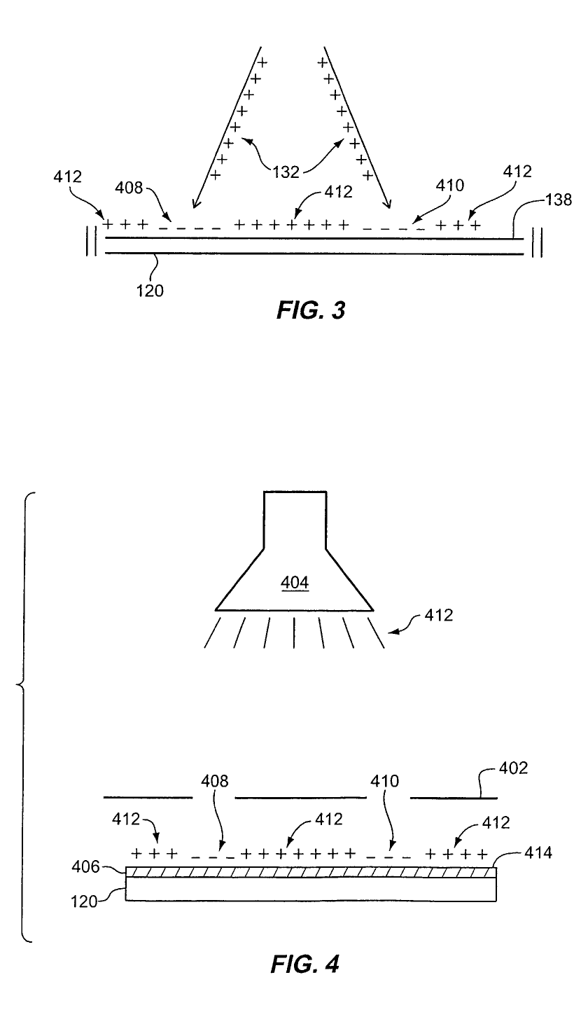

Attention is now directed to FIG. 3. Positively charged droplets 132 preferably flow unobstructed toward substrate surface 138 until the effects of surface charges on surface 138 take effect. When the surface charges take effect, positively charged mist particles 132 are preferably driven toward negatively charged regions 408 and 410 and away from positively charged regions 412. In this manner, precursor material included in droplets 132 preferably accumulates only in negatively charged areas 408 and 410, thereby realizing selective deposition according to the preferred embodiment.

After the deposition, the selectively deposited film composed of the deposited droplets 132 is solidified, preferably by heating and/or drying. Heating is preferably in the form of baking at an appropriate temperature followed by annealing. The baking is preferably in the form of heating on a hot plate and/or rapid thermal processing (RTP sometimes referred to as RTA). The annealing is preferably in the form of RTP and/or may include a furnace anneal. The drying can be in the form of heating and/or in the form of exposure to a vacuum. Accordingly, the disclosed method preferably enables selective deposition of desired solid thin film on a substrate according to a mask pattern. Residual patterning material is burned off in the heating steps and/or dissolved away in subsequent substrate processing. For a detailed description of the solidification process, we refer to U.S. Pat. Nos. 6,022,669; 5,792,592; and 5,849,465 referenced above. While these prior art solidification processes work well with the process of the invention, in general it has been found that, with the process of the invention, good quality solid films can be made at lower temperatures: the baking typically being at temperatures of 250° C. or less, the RTP taking place at temperatures in the range of 450° C. to 750° C., and furnace anneals taking place at temperatures of between 600° C. and 800° C.

When the process is used to make an integrated circuit thin film, as known in the art, after the deposited precursor has been solidified and the residual patterning material removed, the integrated circuit is completed to incorporate the solid thin film into an integrated circuit component.

There have been described what are, at present, considered to be the preferred embodiments of the invention. It will be understood that the invention can be embodied in other specific forms without departing from its spirit or essential characteristics. For instance, each of the inventive features mentioned above may be combined with one or more of the other inventive features. That is, while all possible combinations of the inventive features have not been specifically described, so as the disclosure does not become unreasonably long, it should be understood that many other combinations of the features may be made. The present embodiments are, therefore, to be considered as illustrative and not restrictive. The scope of the invention is indicated by the appended claims.

We claim:

1. A method for selective deposition of precursor material, the method comprising:
providing a substrate having a surface in a deposition chamber;
depositing a photosensitive film on the substrate surface;
selectively exposing a portion of said film to UVL (ultraviolet light), thereby creating an exposed film portion and an unexposed film portion;
providing, in said deposition chamber, a mist of liquid precursor particles having a first polarity; and
utilizing said first polarity to migrate said mist particles to either said exposed film portion or said unexposed film portion to form a precursor film.

2. The method of claim 1 wherein said photosensitive film is organic.

3. The method of claim 1 wherein said selectively exposing comprises directing UVL through a mask toward said deposited film.

4. The method of claim 1 wherein said first polarity is positive.

5. The method of claim 1 wherein said first polarity is negative.

6. The method of claim 1 wherein said utilizing comprises creating an electric field having a second polarity opposite said first polarity at said substrate and said first polarity above said substrate.

7. The method of claim 6 wherein said creating comprises energizing a substrate charging plate with said first polarity.

8. The method of claim 6 wherein said creating comprises grounding a field screen at a neutral end of said electric field.

9. The method of claim 6 wherein said creating comprises locating a substrate charging plate below said substrate.

10. The method of claim 6 wherein said creating comprises locating a field screen above said substrate.

11. The method of claim 1 further comprising exhausting precursor mist particles having a second polarity opposite said first polarity.

12. The method of claim 1 wherein said depositing comprises depositing said migrating particles on said exposed film portion.

13. The method of claim 1 wherein said depositing comprises depositing said migrating particles on said unexposed film portion.

14. The method of claim 1 wherein said depositing comprises repelling said migrating particles from said exposed film portion.

15. The method of claim 1 wherein said depositing comprises repelling said migrated particles from said unexposed film portion.

16. The method of claim 1 wherein said substrate is a microelectronics substrate.

17. The method of claim 1 wherein said substrate is a MEMS substrate.

18. The method of claim 1 wherein said substrate is an integrated circuit substrate, and said method further comprises treating said precursor film to form a solid thin film and completing said integrated circuit to incorporate said solid thin film in said integrated circuit.

19. The method of claim 1 wherein said substrate is an optics substrate.
